(19) United States
(12) Patent Application Publication
(10) Pub. No.: US 2010/0166471 A1
(43) Pub. Date: Jul. 1, 2010

(54) IMAGE FORMING APPARATUS AND FIXING DEVICE

(75) Inventor: Kazuhiko KIKUCHI, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/649,713

(22) Filed: Dec. 30, 2009

Related U.S. Application Data
(60) Provisional application No. 61/142,055, filed on Dec. 31, 2008.

(51) Int. Cl. G03G 15/20

(52) U.S. Cl. 399/331

(57) ABSTRACT

According to an embodiment of the invention, a fixing apparatus including, a first rotating member, a second rotating member which presses a sheet between the first rotating member and the second rotating member with a first pressure to fix a visualizing agent to the sheet, a separation member which separates the sheet from the first rotating member, a pressure control unit which lowers the pressure between the first rotating member and the second rotating member to a second pressure that is lower than the first pressure, and a heating mechanism which does not heat the first rotating member in a first state where the first rotating member does not rotate and the pressure between the first rotating member and the second rotating member is the second pressure, and heats the first rotating member after the first state when the a second state is set in.

### CROSS-REFERENCE TO RELATED APPLICATION

This application is based upon and claims the benefit of priority from U.S. Provisional Application No. 61/142,055 filed on Dec. 31, 2008, the entire contents of which are incorporated herein by reference.

### TECHNICAL FIELD

The present invention relates to a heating device utilizing induction heating, and particularly to a fixing device which is used for an electrographic copying device, printer device or the like using a toner as a visualizing agent and fixes a toner image by using a heating device.

### BACKGROUND

A fixing device having a configuration in which a magnetic flux generated by electrification of a coil acts on an electromagnetic induction heating layer provided on a fixing roller, thus generating heat by Joule heat due to an eddy-current, is practically available.

For example, U.S. Pat. No. 7,043,185B2 discloses that fixing belt is laid over a heating roller and a supporting roller. The fixing belt is situated between the supporting roller and a counter-roller. A recording medium is passed through a nip between the counter-roller and the fixing belt. Thus, a toner image fixed to the recording medium.

Meanwhile, in the fixing device, as the toner situated on the output medium becomes integrated with the output medium, in some cases, the output medium and the toner do not separate from the heating member such as roller or belt (that is, the output medium and the toner may become wound around the roller or belt).

Therefore, a separation mechanism to separate the output medium (and the toner) from the roller or belt is situated near the position where the heating member such as roller or belt contacts the output medium and the toner.

The separation mechanism needs to have a small distance (gap) from the roller or belt. However, the separation mechanism must not contact the roller or belt.

The document (U.S. Pat. No. 7,043,185B2) does not disclose the existence of the separation mechanism and the distance or the size of the gap between the separation mechanism and the roller or belt.

### SUMMARY

An object of the invention is to realize a structure which restrains failure of the output medium (and the toner) to separate from the heating member such as roller or belt due to the integration of the toner situated on the output medium with the output medium (that is, the output medium and the toner being wound around the roller or belt).

Another object of the invention is to prevent the structure to restrain failure of the output medium (and the toner) to separate from the heating member such as roller or belt (that is, the output medium and the toner being wound around the roller or belt), from contacting the roller or belt.

Particularly, a warm-up method is to be realized which prevents the structure to restrain failure of the output medium (and the toner) to separate from the heating member such as roller or belt (that is, the output medium and the toner being wound around the roller or belt), from contacting the roller or belt, at the time of warm-up when the output medium (and the toner) does not exist.

Still another object of the invention is to enhance durability of a roller member using an elastic member in a fixing device included in an image forming apparatus.

According to an aspect of the present invention, there is provided a fixing apparatus comprising:

a first rotating member; a second rotating member which presses a sheet between the first rotating member and the second rotating member with a first pressure to fix a visualizing agent to the sheet;

a separation member which separates the sheet from the first rotating member;

a pressure control unit which lowers the pressure between the first rotating member and the second rotating member to a second pressure that is lower than the first pressure; and

a heating mechanism which does not heat the first rotating member in a first state where the first rotating member does not rotate and the pressure between the first rotating member and the second rotating member is the second pressure, and heats the first rotating member when a second state where the first rotating member rotates and the pressure between the first rotating member and the second rotating member is the first pressure, is set in after the first state.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of an image forming apparatus e.g., multi-functional peripheral according to an embodiment of the invention;

FIG. 2 shows a state (sectional view) where a fixing device included in the image forming apparatus shown in FIG. 1 is extracted and sliced on a plane orthogonal to a rotation axis;

FIG. 3 shows a state where a second (pressurizing) roller is supported by a pressurizing mechanism in the fixing device shown in FIG. 2;

FIG. 4 shows a state where the fixing device shown in FIG. 2 and FIG. 3 is viewed from the side of a first (heating) roller and an induction heating device;

FIG. 5A shows the relation between the pressure (pressurization or depressurization) state between an endless (heating) belt, the first roller and the second roller, and the gap G from a separation blade, in the fixing device shown in FIG. 2;

FIG. 5B show the relation between the pressure (pressurization or depressurization) state between an endless (heating) belt, the first roller and the second roller, and the gap G from a separation blade, in the fixing device shown in FIG. 2;

FIG. 6A illustrates the operation state of a mechanism (eccentric cam) that realizes the pressure (pressurization or depressurization) state between the endless (heating) belt (the first roller) and the second roller shown in FIG. 5A and FIG. 5B, and shows a state where the endless belt situated on the outer circumference of the first roller and the second roller to press hardly each other (with the eccentric cam stopped at the pressurization position);

FIG. 6B illustrates the operation state of the mechanism (eccentric cam) that realizes the pressure (pressurization or depressurization) state between the endless (heating) belt (the first roller) and the second roller shown in FIG. 5A and FIG. 5B, and shows a state where the endless belt situated on the outer circumference of the first roller and the second roller in a state that a pressure between the first roller and the second roller is loosely (with the eccentric cam stopped at the depressurization position);

FIG. 7 shows change in the gap G from the separation blade described in FIG. 5A, FIG. 5B, FIG. 6A and FIG. 6B;

FIG. 8 shows an example of drive control where the change in the gap G from the separation blade descried in FIG. 7 is used at the time of starting operation of the image forming apparatus (from when power is turned on and until the end of warm-up);

FIG. 9 shows an example of a block diagram of an induction heating device driving system capable of preventing damage to a fixing belt even if the gap G from the separation blade described in FIG. 2, FIG. 6A, FIG. 6B and FIG. 8 changes;

FIG. 10 indicates a block diagram of an exemplary modification of the induction heating device driving system; and

FIG. 11 is an exemplary flowchart of control in the modification.

### DETAILED DESCRIPTION

Hereinafter, an example of an embodiment of the invention will be described in detail with reference to the accompanying drawings.

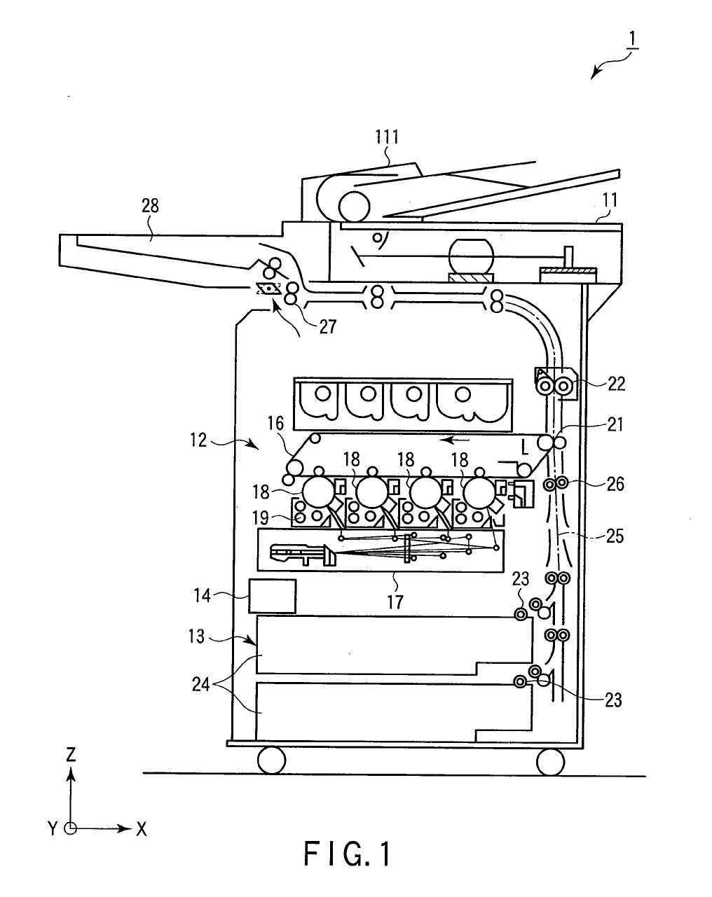

FIG. 1 schematically shows an image forming apparatus to which the invention can be applied.

Hereinafter, configurations are schematically shown in an enlarged, reduced or partly omitted form in the drawings, when it is suitable. In the drawings, X, Y and Z indicate three directions that are orthogonal to each other.

An image forming apparatus 1 has: a scanner 11 which generates an image signal from a target for reading an image; an image forming unit 12 which forms an image (toner image) corresponding to the image signal supplied from the scanner 11 or from outside, and fixes the toner image to a paper P; a sheet supply unit 13 which houses the paper P and supplies the paper to the image forming unit 12; and a control unit (main control block) 14 which controls the operation of each unit (component).

An automatic document feeder 111 which, if a scanning target is sheet-like, sequentially replaces the scanning target interlocking with the image scanning operation of the scanner 11, is integrally provided with the scanner 11.

The image forming unit 12 includes an intermediate transfer belt 16, an exposure device 17, photoconductive drums 18, developing devices 19, a transfer device 21 and a fixing device 22, as will be described later.

The exposure device 17 outputs a laser beam with its light intensity changed according to image information supplied from the scanner 11 or an external device. Light according to image information is exposed to the first to fourth photoconductive drums 18 from the exposure device 17. Electrostatic latent images are formed on the first to fourth photoconductive drums 18.

The first to fourth photoconductive drums 18 are, for example, cylindrical. As the first to fourth photoconductive drums 18 provided with a predetermined potential are irradiated with light, the potential in the area irradiated with light changes. The change in potential is held as electrostatic latent images in the photoconductive areas of the first to fourth photoconductive drums 18 during a predetermined time period.

The first to fourth developing devices 19 selectively supply a toner (developer) to the electrostatic latent images held by the first to fourth photoconductive drums 18 and thereby visualize the images formed on the individual photoconductive drums 18.

The first to fourth developing devices 19 house toners of arbitrary colors such as Y (yellow), M (magenta), C (cyan) and Bk (black) used to provide a color image by a subtractive process and visualize the latent image held by each corresponding photoconductive drum 18 in one of the colors of Y, M, C and Bk. The order of colors is decided in a predetermined order according to the image forming process and the characteristic of the toners.

The intermediate transfer belt 16 holds the toner images of the respective colors formed by the first to fourth developing devices 19 (each of) on the corresponding photoconductive drums 18 (each of) in order of the toner image formation.

The transfer device 21 transfers, by an electric field, an aggregate of the first to fourth toners stacked on the intermediate transfer belt 16 to a paper P taken out one by one from a sheet cassette 24 by a pickup roller 23 of the sheet supply unit 13 and carried and supplied in advance to an aligning roller 26 through a carrying path 25. The paper P is controlled in predetermined timing by a pause by the aligning roller 26 so that the position of the paper P is aligned with the position of the toner images stacked on the intermediate transfer belt 16. The paper P is thus guided to a transfer position where the transfer device 21 contacts the intermediate transfer belt 16.

The toner transferred to the paper P by the transfer device 21 is carried to the fixing device 22. As a pressure is applied at the same time when the toner is melted by the fixing device 22, the toner is fixed to the paper P.

The paper P having the toner image fixed thereto by the fixing device 22 is discharged to a paper discharge tray 28 by a paper discharge roller 27 and stacked in order.

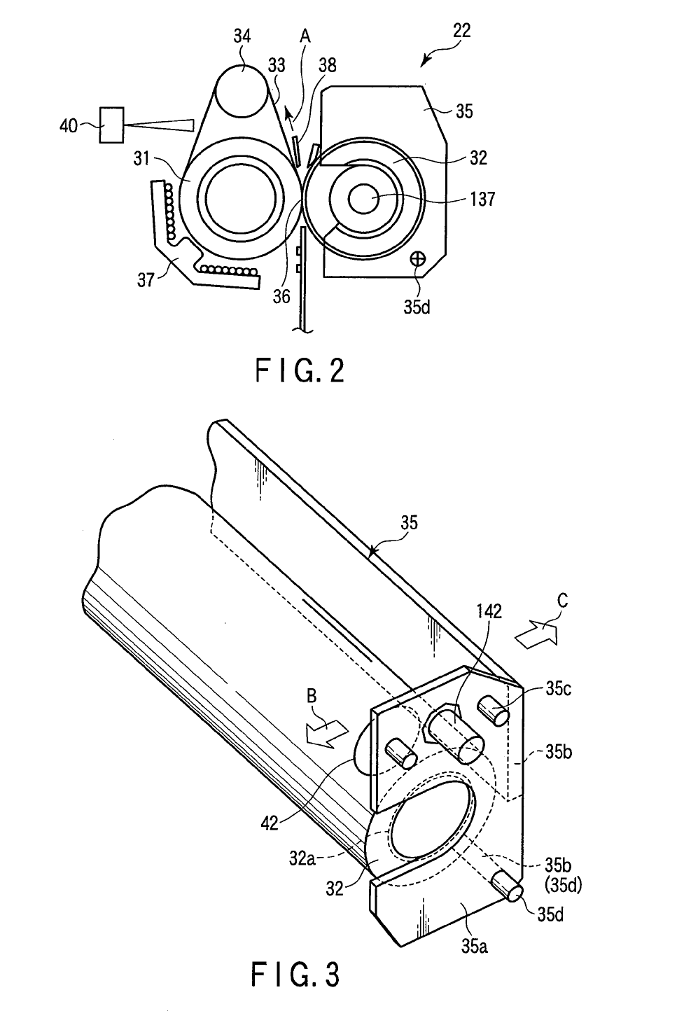

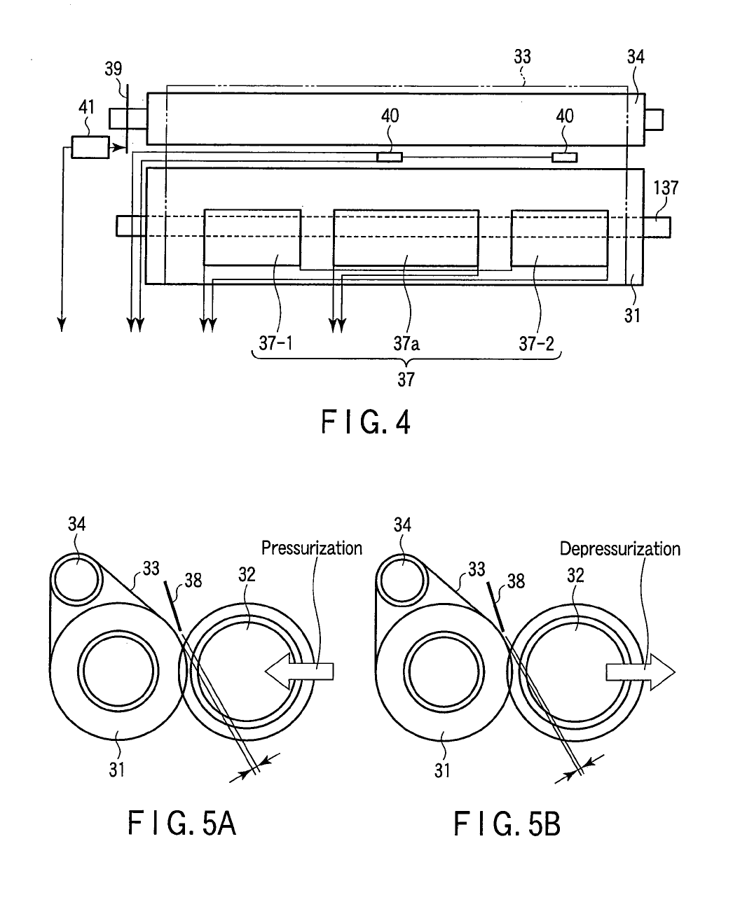

The fixing device 22 will be described hereinafter with reference to FIG. 2, FIG. 3 and FIG. 4. The fixing device 22 includes two roller members, that is, a first roller 31 and a second roller 32 arranged in a manner that their axial lines become parallel to each other, with the second roller 32 being pressed against the first roller 31 by a predetermined pressure. The fixing device 22 also includes an endless belt 33 provided on the outer circumference of the first roller 31, and a third roller 34 which provides a predetermined tension to the endless belt 33 in cooperation with the first roller 31. The second roller 32 receives a pressure toward the first roller 31 from a pressurizing mechanism 35. As the second roller 32 rotates, an arbitrary part of the endless belt 33 that is parallel to the rotation axis of the third roller 34 continuously moves in the direction of arrow A (the movement of the arbitrary part of the endless belt 33 in the direction of arrow A is a movement for the endless belt 33 to transmit the rotation of the second roller 32 to the first roller 31). The third roller 34 is situated downstream of the direction of rotation of the first roller 31 (on the side opposite to the side where the paper P enters the fixing area with respect to the position where the endless belt 33 passes the fixing area to contact the second roller 32).

The first roller (heating roller) 31 includes a core metal (shaft) using a hollow metal pipe with an outer diameter φ of 30 mm and a thickness t of 3 mm, and a porous silicone sponge layer (a cell layer, that is, an elastic member) formed on the outer circumference of the core metal. It is preferable that iron or an iron-based material is used as the core metal in consideration of magnetic circuit matching at the time of induction heating by an induction heating device. The base material of the elastic member (cell layer (body part)) is, for example, a silicone rubber and this layer has a thickness of 5 to 15 mm. In this embodiment, the thickness is t=9.25 mm. Therefore, the diameter φ of the first roller 31 is 48.5 mm. It is preferable that the diameter of the cells contained in the elastic member (porous cell layer) (that is, the (average) diameter of individual pores) is 50 μm or smaller. The porous silicone sponge layer (cell layer) has a characteristic that its hardness gradually increases if the layer is pressurized and heated for a long time. The porous silicone sponge layer has a heat capacity of 45 [J/K].

The second roller (pressurizing roller) 32 includes a core metal using a hollow metal pipe with an outer diameter φ of 46 mm and a thickness t of 2 mm, a silicone rubber layer covering the outer circumference of the core metal and having a thickness t of 2 mm, and a tube made of a copolymer of perfluoroalkoxy ethylene and ethylene tetrafluoride (PFA) covering the silicone rubber layer. The PFA tube preferably has a thickness of 30 μm. A fluoro rubber or the like may be used instead of the PFA tube. The second roller 32 includes a heater 137 that is independent of an induction heating device which will be described later. The heater can be, for example, a halogen lamp.

The endless belt (fixing belt) 33 has an adhesive layer, an elastic layer and a release layer on a base layer (base material) made of a Ni alloy (a thin film member made of an electrically conductive metal) containing Ni mainly, for example, with a thickness of approximately 40 μm. For the base material (base layer), for example, stainless steel, aluminum, a composite material (alloy) of stainless steel and aluminum, or the like can be used. The adhesive layer has heat resistance at least to approximately 250° C. and has a thickness of, for example, 20 μm. The elastic layer is a plate-like member made of, for example, a 200-μm-thick silicon rubber (solid, that is, containing no pores). The release layer is made of a fluorine-based resin, for example, a copolymer of perfluoroalkoxy ethylene and ethylene tetrafluoride (PFA) having a thickness of, for example, 30 μm. The thickness of the metal layer of the base layer can be arbitrarily selected from the range of 30 to 70 μm. The thickness of the elastic layer (silicone rubber layer) can be arbitrarily selected from the range of 0.1 to 0.5 mm (100 to 500 μm). The thickness of the release layer (PFA layer) can be arbitrarily selected from the range of 0.03 to 0.2 mm (30 to 200 μm).

The third roller 34 has the shape of a hollow cylinder (pipe) made of aluminum, for example, having an outer diameter φ of 17 mm and a thickness t of 2mm. A flange made of iron or stainless steel is situated at axial end parts (both ends) of the third roller 34. The surface of the roller body (body part), that is, of the pipe-shaped area, has a coating layer (release layer) using PFA, DLC (diamond-like carbon) or the like. As the material of the roller body (body part), iron, copper, stainless steel or the like can also be used. The roller body (body part) has a heat capacity of 15 [J/K], which is smaller (less) than the heat capacity of the first roller 31). It is preferable that the heat capacity of the third roller 34 is 15 [J/K] or greater. It is preferable that the outer diameter of the third roller 34 is ½ of the outer diameter of the first roller 31 or smaller.

The third roller 34 can include therein a heat equalizing member, that is, a heat pipe structure. The heat pipe is made of a material having a high thermal conductivity, for example, Al (aluminum) or an alloy containing Al, and has a higher thermal conductivity than the thermal conductivity of the roller body. The heat pipe has a greater coefficient of thermal expansion than that of the roller body and such a strength that its outer diameter does not change after the heat pipe expands inside (the strength is set by the combination of physical properties or viscosity of the material, thickness and so on). As the heat pipe is included inside, the thermal conductivity of the roller body is improved and the range of temperature difference generated on the roller surface is reduced. Also, even if temperature difference occurs, the temperature difference is solved within a short time (roughly within 60 seconds).

As the paper P holding the toner image (toner) passes a nip (fixing area) 36 where the endless belt 33 situated on the outer circumference of the first roller 31 contacts the second roller 32, the paper P firmly holds the melted toner (that is, the toner is fixed to the paper P).

Near the outer circumference of the first roller 31 and the endless belt 33, an induction heating device 37 is situated which provides a magnetic force to the first roller 31 and the endless belt 33 to generate an eddy-current on each of the first roller 31 and the endless belt 33. The induction heating device 37 is arranged in an area where the endless belt 33 is situated upstream of the nip 36 and downstream of third roller 34, on the outer circumference of the first roller 31. Therefore, heat generated by the eddy-currents can be efficiently supplied to the fixing position (nip) 36 between the endless belt 33 and the second roller 32.

Near the nip 36 and near the endless belt 33 in the direction in which the paper P proceeds after passing the nip 36, a separation blade 38 is situated which restrains adherence of the paper P to the endless belt 33 because of the viscosity of the toner.

The pressurizing mechanism 35 includes: (two) supporting plates 35a supporting bearing parts (two sets situated at both ends in the longitudinal direction of the second roller 32) 32a incorporated in the metal core of the second roller 32; at least two connection bars 35b connecting the supporting plates 35a with each other; a pressurizing shaft 35c which provided integrally with the supporting plates 35a and receives a pressure for pressing the second roller toward the first roller 31; and a fulcrum 35d which enables the supporting plate 35a to turn so that the second roller 32 supported by the supporting plates 35a move in the direction of arrow B toward the first roller 31 (the endless belt 33) or in the direction of arrow C away from the first roller 31 (the endless belt 33) according to the provision or interruption (release) of the pressure to the pressurizing shaft 35c, as shown in FIG. 3. One of the connection bars 35b may also serve as the fulcrum 35d (that is, one of the connection bars 35b can be inserted through the supporting plates 35a and the end parts of the connection bar 35b can be used as the fulcrum 35d). Alternatively, instead of the connection bar 35b, both ends of a metal plate can be bent to form the supporting plates 35a.

FIG. 4 shows a state where the fixing device described with reference to FIG. 2 is viewed from a different direction.

The third roller 34 has a blade (or a pulse generator (PG) made of a disk-like thin plate having slits at predetermined intervals (angles) 39 that can detect whether the third roller 34 is rotating or not, on one end side on the axial line.

At least two temperature. sensors (temperature detection mechanisms) 40 are situated at predetermined positions in the longitudinal direction of the endless belt 33. The temperature sensors 40 are non-contact sensors and employ, for example, a thermopile system to detect infrared rays. Thermistors may also be used as the temperature sensors 40. The number of the sensors may be three or greater. However, at least one temperature sensor is situated roughly at the center in the longitudinal direction of the endless belt 33 (the first roller 31).

At a position where the blade (PG) 39 can be detected, for example, a reflection (optical) sensor 41 is situated. As described above, the blade (PG) 39 detects the rotation of the third roller 34. If a slip between the third roller 34 and the endless belt 33 is “0”, the blade (PG) 39 can detect the moving speed of the endless belt 33 as well.

The induction heating device 37, which is already used in a broad range of applications, generates a predetermined magnetic field as a current having a frequency of, for example, approximately 40 kHz, is supplied. This magnetic field causes generation of Joule heat in accordance with the resistance value of the conductive part of the endless belt 33 and the first roller 31, and each of the endless belt 33 and the first roller 31 generates heat. The frequency is controlled, for example, within the range of 40 to 80 kHz in accordance with heat (temperature) detected by the individual sensors 40. To control the frequency, many control methods can be used by the control block 14 or an IH controller (not shown) prepared for this particular purpose.

The induction heating device 37 can adopt one of the configurations in the U.S. patent applications by the development group including the inventor of this application or a combination of the configurations, such as a configuration including a core, a configuration including no core, a configuration having a coil, a configuration having two or more coils divided at arbitrary positions in the longitudinal direction of the roller and belt, or a configuration having two or more coils provided corresponding to the center and both ends in the longitudinal direction of the roller and belt.

As an example of the induction heating device 37, coils are provided corresponding to the center and both ends in the longitudinal direction of the roller and belt. FIG. 4 shows an example in which three coils 37a, 37-1 and 37-2 (37b) are prepared. The coils 37-1 and 37-2 situated on both sides of the center coil 37a are connected in series. A current of a predetermined frequency is supplied to the center coil 37a and the coils 37-1 and 37-2 (37b) situated on both sides.

As a method of supplying a current to the coils, various (current supply) methods can be used such as supplying a current to all the coils simultaneously, supplying a current to either the center coil or the side coils, supplying a current to both the center and side coils (all the coils) simultaneously but defining the total quantity of current within a predetermined range (that is, supplying a current having a resonance frequency of the center and side coils is supplied simultaneously), or changing the duty of each current in the case of pulse control.

The heating (temperature rise) of the first roller 31 and the endless belt 33 by the induction heating device 37 and the heating of the second roller 32 by the heater 32a may be used at the same time. It is also possible to operate the heater 32a of the second roller 32 alone in an auxiliary manner in a case where there is no input (lack) of an image formation request (image formation input) for a predetermined period (when the device is in a sleep mode).

FIG. 5A and FIG. 5B show change in the gap between the endless belt and the separation blade in the case where the pressure between the endless belt and the second roller is changed with the second roller being pressed against the endless belt (the first roller) by the pressurizing mechanism shown in FIG. 3.

It is already described that the separation blade 38 reduces the adherence of the paper P to the endless belt 33 because of the viscosity of the toner. The gap between the separation blade 38 and the endless belt 33 is set to a very narrow gap (approximately 0.2 mm) in order to enhance separation capability of the paper P.

In normal image formation, the endless belt 33 (the first roller 31) receives a predetermined pressure from the second roller 32 as shown in FIG. 5A. Thus, the distance between the endless belt 33 and the separation blade 38 is maintained. However, for example, in a corporate office or the like, when the power source of the image forming apparatus 1 is turned on with the lapse of a predetermined time after the power source is turned off after work is finished or the like (for example, when work starts on the next day), or in the case where a non-image forming state is maintained for a predetermined time or longer and then shifts to a sleep (standby) state, the pressure provided between the first roller 31 and the second roller 32 is reduced in order to restrain deformation of the first roller 31 and the second roller 32. This reduction in the pressure between the first roller 31 and the second roller 32 can be realized by moving the second roller 32 away from the first roller 31 as shown in FIG. 5B.

Meanwhile, the reduction in the pressure between the rollers causes increase in the outer diameter of the first roller 31 (expansion of the first roller 31) and induces to contact with the separation blade 38 and the endless belt 33. If the contact of the separation blade 38 with the endless belt 33 continues for a long time, scratches may be generated on the surface of the endless belt 33 and may cause defects in images after the fixation (image output).

It is known that the outer diameter of the first roller 31 is also increased by heat generation of the first roller 31, as well as the increase in the outer diameter of the first roller 31 due to the reduction in the pressure between the rollers.

That is, in the state (at the depressurization position) where the second roller 32 is pressurized against the first roller 31 hardly as shown in FIG. 5A, the sponge forming the first roller 31 is concaved and the gap G between the separation blade 38 and the endless (heating) belt 33 (situated on the outer circumference of the first roller 31) becomes greater. On the other hand, at the depressurization position (in the state where the second roller 32 is away from the first roller 31), as shown in FIG. 5B, the width of the nip 36 decreases. Therefore, there is little deformation of the sponge part of the first roller 31 and the gap G between the separation blade 38 and the endless belt 33 becomes narrower. The depressurization state may include a state where the second roller 32 is away from the first roller 31.

In normal printing (image formation), the two rollers are in the pressurization state. Therefore, if the gap G between the separation blade 38 and the endless belt 33 is set to the minimum gap in the pressurization state, and when if the state that a pressure between the first roller and the second roller is loosely, the separation blade 38 and the endless belt 33 contact with each other. Also, in heating for image formation, since the sponge part forming the first roller 31 thermally expands, the gap G between the separation blade 38 and the endless belt 33 becomes narrower.

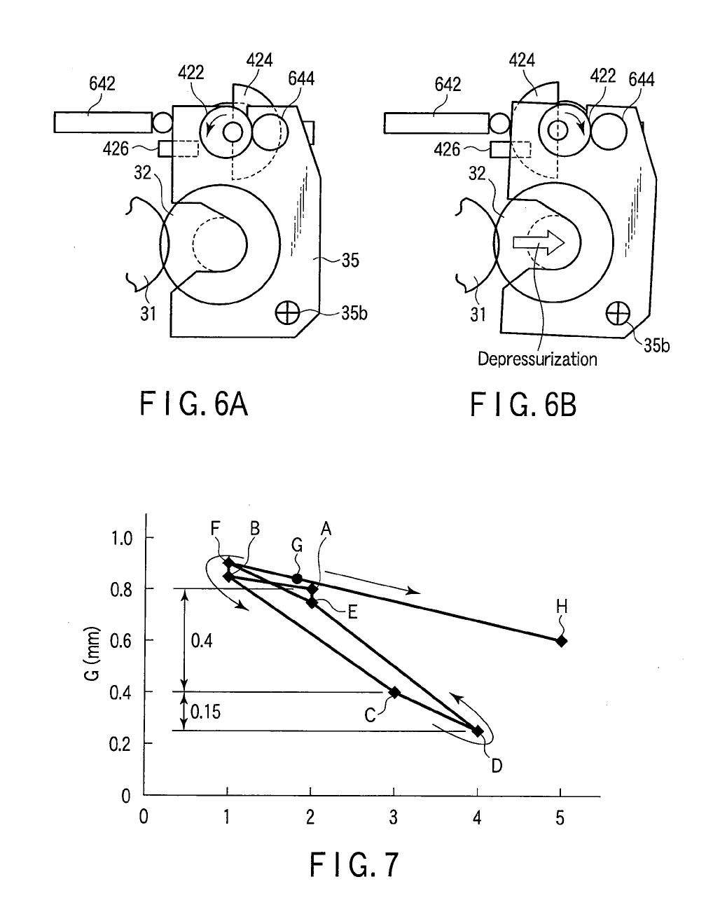

Therefore, as will be described hereinafter with reference to FIG. 6A, FIG. 6B and FIG. 7 (FIG. 3), it is preferable that a cam mechanism (eccentric cam) 42 provided on the supporting plates 35a of the pressurizing mechanism 35 is used to control the gap G between the endless belt 33 and the separation blade 38 at the time of starting operation of the image forming apparatus (from when power is turned on and until the end of warm-up). A spring 642 applies force on the supporting plates 35a for rotating around the connection bar 35b in a direction to increase the pressure at the nip 36. The cam mechanism 42 obtains a rotational force from a cam motor 142 to push a pin 644 connected on the supporting plates 35a to loosen the pressure in the nip 36 in the depressurization state.

In the pressurization state, the cam motor 142 rotates the cam mechanism 42 to loose a counter force against the spring 642. Then, the pressure in the nip 36 is increased.

The cam mechanism 42 has an eccentric cam portion 422 and a collar portion 424. The eccentric cam portion 422 and the collar portion 424 have a common axis to rotate together with each other. The eccentric cam portion 422 contacts with the pin 644. A photo-interrupter 426 detects the collar portion 424 to detect a rotation angle of the eccentric cam portion 422.

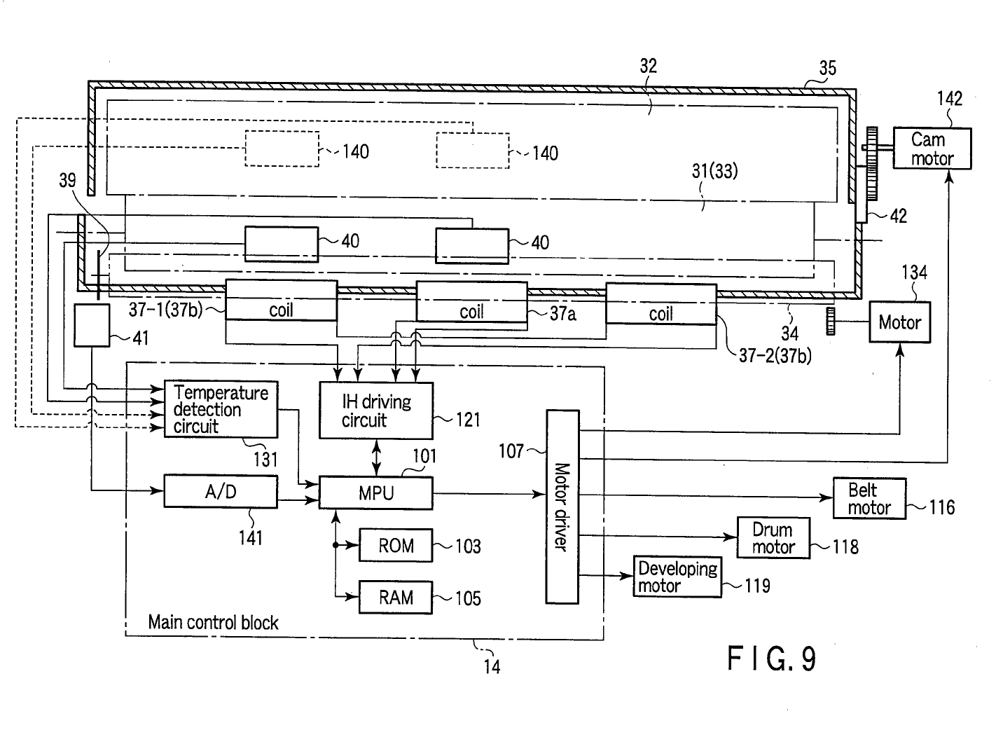

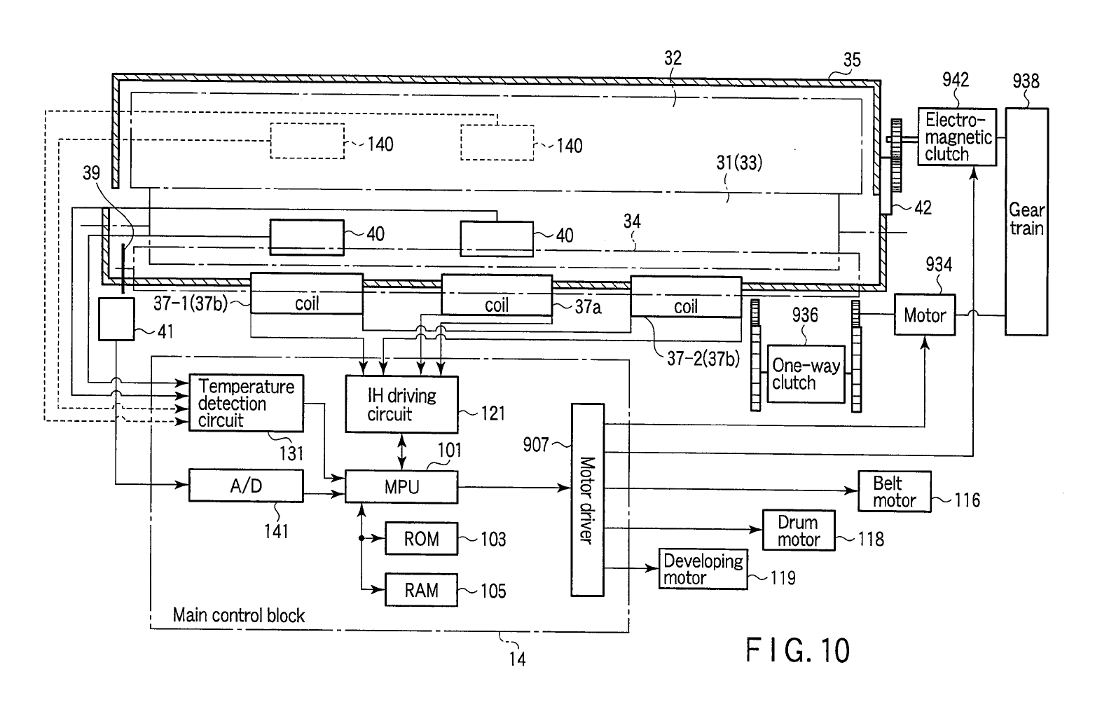

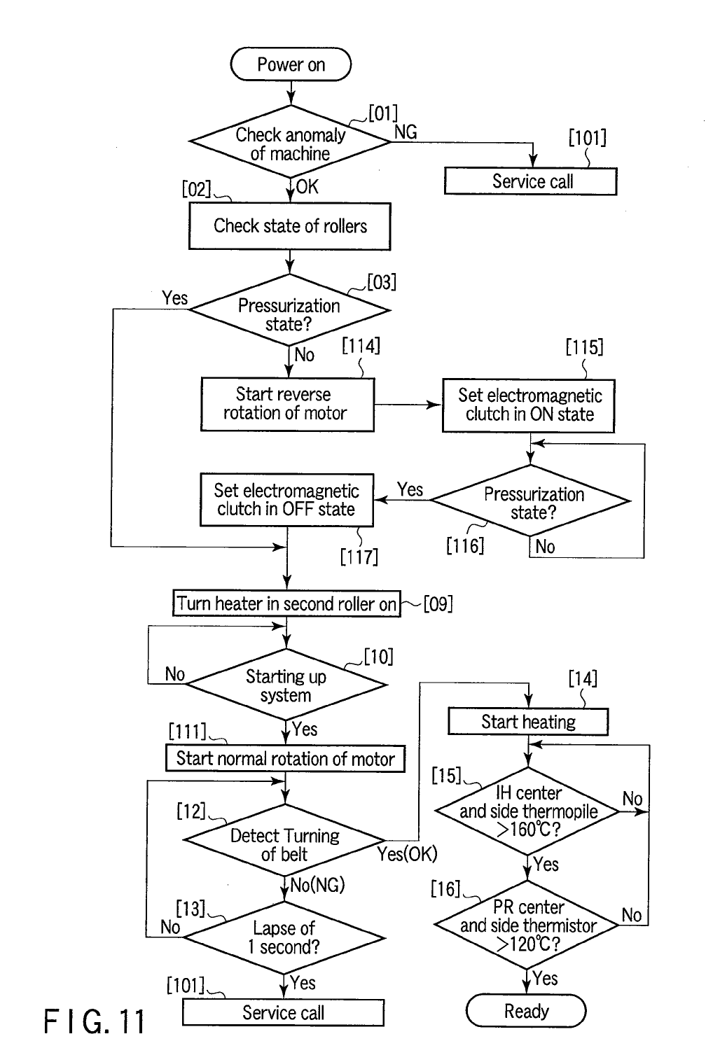

The cam mechanism 42 is rotated in a predetermined direction by the cam motor 142, which will be described later with reference to FIG. 9. Instead of using the can motor 142, the cam mechanism 42 can also be operated by the reverse rotation of a motor 134 which rotates the second roller 32 and a clutch mechanism, as a modification described with FIGS. 10 and 11.

As shown in FIG. 7, in a non-heating state (where the induction heating device 37 is off and the temperature of each roller is substantially the temperature of the installation environment), in the case that the pressure between the second roller 32 and the endless belt 33 (the first roller 31) is loosely (that is, the cam mechanism 42 stops at the depressurization position (FIG. 6B)) and the distance (gap G) between the separation blade 38 and the endless belt 33 is 0.8 mm as indicated by sample A at position 2 on the horizontal axis, if the second roller 32 is pressurized against the endless belt 33 hardly (that is, the cam mechanism 42 stops at the pressurization position (FIG. 6A)), the gap G becomes greater than 0.8 mm as indicated by sample B at position 1 on the horizontal axis.

In the state where the second roller 32 is pressurized against the endless belt 33 (the first roller 31) hardly (that is, the cam mechanism 42 stops at the pressurization position (FIG. 6A)), if the temperature of the endless belt 33 and the first roller 31 is raised (that is, heated by the induction heating device 37), the gap G becomes approximately 0.4 mm as indicated by sample C at position 3 on the horizontal axis, because of the expansion of the first roller. In this state, if the second roller 32 is moved away from (that is, not in contact with) the endless belt 33 (the first roller 31) (that is, the cam mechanism 42 stops at the depressurization position (FIG. 6B)), the gap G becomes approximately 0.25 mm as indicated by sample D at position 4 on the horizontal axis. The management value of the gap G in consideration of component accuracy (dimensional error of the separation blade 38 and the first roller 31, attachment error of the separation blade 38, and so on) needs to be approximately 0.2 mm at a maximum. If the above positions 1 to 4 on the horizontal axis are repeatedly taken, the separation blade 38 may contact the endless belt 33.

Meanwhile, if the heating by the induction heating device 37 is stopped in the state of sample D at position 4 on the horizontal axis, the gap G becomes approximately 0.75 mm after the lapse of a predetermined time and approaches the initial value of the gap G (of the non-heating or depressurization state), as indicated by sample E at position 2 on the horizontal axis. If the number of samples is increased, the value may coincide with that of sample A. Then, if the second roller 32 is pressurized against the endless belt 33 (the first roller 31) hardly again (that is, the cam mechanism 42 stops at the pressurization position (FIG. 6A)), the gap G becomes greater again as indicated by sample F at position 1 on the horizontal axis. If the number of samples is increased, the value may coincide with that of sample B. Similarly, if the non-heating state is maintained and the cam mechanism 42 stops at the depressurization position (FIG. 6B) in order to the pressure between the second roller 32 and the endless belt 33 is loosely, the gap G approaches the initial value of the gap G (of the non-heating or depressurization state), as indicated by sample G at position 2 on the horizontal axis. If the number of samples is increased, the value may coincide with that of sample A or sample E. By the way, sample H at position 5 on the horizontal axis is an example of the gap G in a non-control state where the pressure between the first roller 31 and the second roller is loosely as a power-off state of the image forming apparatus 1 continues in the heating by the induction heating device 37. This example shows that the gap is an arbitrary gap of 0.4 to 1.0 mm.

From the above, in the sample D in FIG. 7, it can be seen that the gap G becomes the narrowest (smallest) at the time of heating and depressurization (when the temperature of the first roller 31 and the endless belt 33 is raised by the induction heating device 37 in the state that the pressure between the first roller 31 and the second roller is loosely). On the other hand, in the sample B or F in FIG. 7, it can be seen that the gap G becomes the broadest (largest) at the time of heating and pressurization (when the provision of a magnetic field from the induction heating device 37 is off in the state where the second roller 32 is pressurized against the endless belt 33 hardly).

In order to prevent occurrence due to the contact of the separation blade 38 with the endless belt 33 at the time of heating and pressurization (sample D in FIG. 7), which is the operation state of printing (at the time of image formation), a margin of approximately 0.15 mm needs to be taken as the amount of change in the gap G from sample C (pressurization and heating) to sample D (depressurization and heating) in FIG. 7. Meanwhile, if 0.3 mm is added as the management value of the gap G in consideration of the above component accuracy, at least 0.5 mm must be secured as the gap G between the endless belt 33 and the separation blade 38.

However, the gap G of at least 0.5 mm is too large for the separation blade 38 to function sufficiently. On the other hand, it is confirmed by the inventors that no image defect occurs if the rotation of the first roller 31 is stopped to restrain the movement of the endless belt 33 (that is, to maintain the stop state) even in the state where the separation blade 38 is in contact with the endless belt 33.

As this condition is maintained (that is, the first roller 31 is not rotated if the separation blade 38 is in contact with the endless belt 33), the separation blade 38 can be brought closer to the endless belt 33 by the amount of 0.3 mm added as the management value of the gap G in consideration of the above component accuracy. Thus, even if the component accuracy or the like is considered, the adherence of the paper P to the endless belt 33 based on the viscosity of the toner can be substantially prevented by the separation blade 38 (that is, the gap G of approximately 0.2 mm can be maintained at the time of heating and pressurization).

According to this example, in a fixing device including a roller using an elastic member that deforms (or becomes compressed) by receiving a pressure and that thermally expands, a separation mechanism which reduces adherence of a toner to the surface of the elastic member (roller member) is fixed in a state of being in contact with the surface of the elastic member prescribed by temporary removal of the pressure provided to the elastic member in the state where required heat is supplied to the elastic member, at the time of situating the depressurization mechanism near the surface of the elastic member while maintaining a gap that does not cause image defect. Thus, at the time of image formation, such a gap can be set that the depressurization mechanism does not contact the surface of the elastic member.

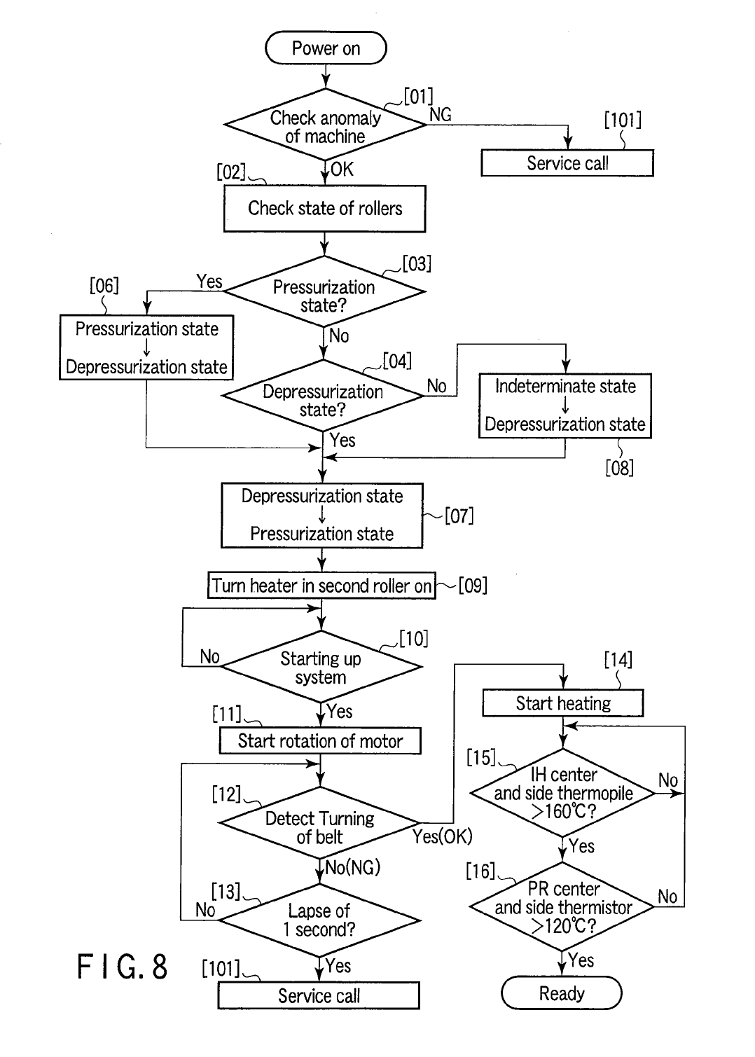

An example of control in the startup of the image forming apparatus that incorporates the fixing device using the elastic member with the above properties will be described with reference to FIG. 8.

As described above, even in the case where the separation blade 38 is in contact with the surface of the endless belt 33, no image defect occurs when the fixing device is used if the belt surface of the endless belt 33 does not move.

Thus, in this example, at the time of warm-up of the image forming apparatus 1 (that is, a state where a temperature rise of the fixing device is required for a relatively long time until image formation is enabled with the lapse of a predetermined time after the power source of the apparatus is turned off), or when image formation is designated after a ready state where warm-up ended and an image formation-enabled state is maintained, and the temperature of the fixing device is to be raised to a temperature that enables image formation, the heating roller or the fixing belt (heating belt) of the fixing device is not rotated or turned under the following conditions. The heater 137 on the side of the second roller 32 is turned on in predetermined timing irrespective of whether or not to rotate the roller.

Specifically, when the power source of the image forming apparatus is turned on and initialization of the control system is finished, anomaly check of the entire image forming apparatus (machine anomaly check) is carried out (ACT [01]). If the presence of certain anomaly in the image forming apparatus 1 is confirmed as a result of the machine anomaly check, an error indication (for example, “service call” or the like) is displayed on a display unit, not shown, which is provided on an operation panel in many cases (ACT [1-NO] to ACT [101]).

When the absence of anomaly in the image forming apparatus 1 is confirmed as a result of the machine anomaly check (ACT [01-YES]), the gap between the first roller and the second roller is checked (ACT [02]) and a “pressurization—depressurization initialization” routine to set (or initialize) the gap in a predetermined state is executed if a pressure between the first roller 31 and the second roller 32 is higher than predetermined pressure. The gap between the first roller and the second roller can be checked according to a rotation angle of the cam mechanism 42 detected by the photo-interrupter and the collar portion. The first roller is a heating roller that opposite to the toner surface of a sheet-like medium (paper P) holding an output image. The second roller is a pressurizing roller that provides a predetermined pressure to the heating roller (first roller) from the back (non-toner surface) side of the sheet-like medium (paper P) holding the output image.

If the first roller and the second roller are in the pressurization state (ACT [03-YES]), the first roller and the second roller are shifted in a depressurization state where a pressure between the first roller 31 and the second roller 32 is lower than predetermined pressure. If the first roller and the second roller are not in the pressurization state (ACT [03-NO]), it is checked a pressure between the first roller 31 and the second roller 32 is lower than predetermined pressure (in the depressurization state) (ACT [04]). If the rollers are not in the depressurization state, either (ACT [04-NO]), the state of the rollers is determined as an indeterminate state. If the first roller and the second roller are in the intermediate state, the first roller and the second roller are shifted in the depressurization state (ACT [08]).

From the depressurization state detected in the act [04] or set in acts [06] or [08], shifted to the pressurization state (ACT [07]).

After shifting to the pressurization state, the heater 137 provided on the second roller is turned on (ACT [09]).

Then, when startup check (system startup) such as operation check of each unit is finished following the initialization of the control system (ACT [10-YES]), the second roller 32 is rotated the endless belt 33 receives and follows the rotation of the second roller 32 in the nip (36)) (ACT [11]). At the same time, the rotation of the blade (PG 39) prepared coaxially with the third roller is detected by the sensor 41 (ACT [12]). If the sensor 41 cannot detect the rotation of the blade (39) (ACT [12-NO]), after the lapse of a predetermined time (ACT [13-YES]), an error indication (for example, “service call” or the like) is displayed on the display unit, not shown, which is provided on the operation panel in many cases (ACT [101]).

When it is detected that each roller and the endless belt of the fixing device are rotating or turning (ACT [12-YES]), the induction heating device (37) is started up and heat generation of the first roller and the endless belt starts (ACT [14]).

Then, each roller and the endless belt of the fixing device are rotated and a current of a predetermined frequency is supplied to each of the coils 37-1 and 37-2 (37b) of the induction heating device 37 until it is detected from the outputs of the sensors 40 that the temperature is raised to 160° C. both at a roughly central part and side ends of the endless belt (ACT [15-YES]) and that the temperature is raised to 120° C. at a roughly central part and side ends of a thermistor 140 (PR) on the second roller side (ACT [16-YES]).

If it is detected from the outputs of the sensors 40 that the temperature is raised to 160° C. both at a roughly central part and side ends of the endless belt and that the temperature is raised to 120° C. at a roughly central part and side ends of the thermistor 140 on the second roller side, a transition to a ready state is made. However, if the third roller is rotating, the endless belt (the first roller) and the second roller are always maintained in the “pressurization state”.

FIG. 9 shows an example of a block diagram of an induction heating device driving system capable of having the gap G from the separation blade described with reference to FIG. 2, FIG. 6A, FIG. 6B and FIG. 8.

The main control block (control unit) 14 includes a microprocessor (MPU) 101 which functions as a main controller, and an IH driving circuit 121 which supplies power of a predetermined frequency to the center coil 37a and the two side coils 37-1 and 37-2 (37b) of the induction heating device 37. Power supplied to each coil by the IH driving circuit 121 is set as power and frequency to be supplied to each coil from the IH driving circuit 121, by the MPU 101 referring the a comparative value (reference quantity or set value) held in a data memory (ROM) 103 on the basis of temperature data acquired by converting, by a temperature detection circuit 131, temperature information detected by the sensor 40 that detects the temperature of at least either the roughly central part of the endless belt 33 or the side-end areas on both sides of the central part. That is, power and frequency to be outputted by each coil of the induction heating device 37 is set on the basis of the detected temperature information. The temperature information, the output from the thermistor 140 on the second roller side can also be used. It is possible to refer to the outputs of both thermistors.

A third roller rotation detection signal from the sensor 41 is inputted to the MPU 101 via an A-D converter 141. It is thus determined whether the third roller 34 is rotating or not.

A belt motor 116 which supplies a thrust to the intermediate transfer belt 16, a drum motor 118 which rotates the photoconductive drums 18, a developing motor 119 which drives the developing devices 19, the fixing motor 134 which rotates the second roller 32, and a motor driver 107 which controls rotation of a motor group including a cam motor 142 or the like which rotates the cam mechanism (eccentric cam) 42 provided in the pressurizing mechanism 35 of the fixing device 22 by a predetermined angle every time a control input is provided, are connected to the MPU 101. The MPU 101 controls the individual motors in accordance with a basic program held in the ROM 103.

As a matter of course, control information including, for example, the operation (rotation angle) of the cam motor 142 which drives the eccentric cam (cam mechanism) 42 and the result of the operation, or whether the second (pressurizing) roller 32 and the endless belt 33 (the first roller 31) are the “pressurization state”, is held in a work memory (RAM) 105.

As described above, in the fixing device to which the embodiment of the invention is applied, a structure can be realized which reduces failure of the output medium (and the toner) to separate from the heating member such as the roller or belt (that is, the output medium and the toner being wound around the roller or belt) due to the integration of the toner situated on the output medium with the output medium.

FIG. 10 indicates a block diagram of an exemplary modification of the induction heating device driving system. The modification includes a motor 934, a one-way clutch 936, a gear train 938, an electromagnetic clutch 942 and a motor driver 107 instead of the motor driver 107, the motor 134 and the cam motor 142.

The motor 934 rotates the one-way clutch 936 and the gear train 938. The one-way clutch 936 transfers a normal rotation of the motor 934 to the second roller 32 and isolates the second roller 32 from a reverse rotation of the motor 934. The second roller 32 rotates in a direction for taking the sheet P into the nip 36 by the normal rotation of the motor 934.

The gear train 938 transfers the reverse rotation of the motor 934 to the electromagnetic clutch 942. The electromagnetic clutch 942 transfers the reverse rotation of the motor 934 to the cam mechanism 42 to loosen the pressure between the second roller 32 and the endless belt 33 in ON state. The electromagnetic clutch 942 in the ON state and the reverse rotation of the motor 934 makes the first roller 31 and the second roller 32 the depressurization state.

The electromagnetic clutch 942 isolates the rotation of the motor 934 to the cam mechanism 42 in OFF state. The electromagnetic clutch 942 in the OFF state makes the first roller 31 and the second roller 32 in the pressurization state.

A motor driver 907 controls a rotation angle and a rotation direction of the motor 934 and the state of the electromagnetic clutch 942.

FIG. 11 is an exemplary flowchart of control in the modification. In the modification, acts [114]-[117] and [111] are employed instead of the acts [04]-[08] and [11] in the FIG. 8.

If the first roller and the second roller are not in the pressurization state (ACT [03-NO]), the motor 934 starts the reverse rotation (ACT [114]) and the electromagnetic clutch 942 shifts to ON state to rotate the cam mechanism 42 (ACT [115]). The cam mechanism 42 is rotated during the first roller and the second roller are not in the pressurization state (ACT [116-NO]). After the first roller and the second roller are set in the pressurization state (ACT [116-YES]), the electromagnetic clutch 942 shifts to OFF state stop the rotation of the cam mechanism 42(ACT [117]). After the heater 137 is turned on at ACT [09], the motor 934 starts the normal rotation (ACT [114]).

Also, the structure to restrain failure of the output medium (and the toner) to separate from the heating member such as the roller or belt (that is, the output medium and the toner being wound around the roller or belt) can be prevented from contacting the roller or belt.

Moreover, a warm-up method can be realized which prevents the structure to restrain failure of the output medium (and the toner) to separate from the heating member such as the roller or belt (that is, the output medium and the toner being wound around the roller or belt), from contacting the roller or belt, at the time of warm-up when the output medium (and the toner) does not exist.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a first rotating member;
a second rotating member which presses a sheet between the first rotating member and the second rotating member with a first pressure to fix a visualizing agent to the sheet;
a separation member which separates the sheet from the first rotating member;
a pressure control unit which lowers the pressure between the first rotating member and the second rotating member to a second pressure that is lower than the first pressure; and
a heating mechanism which does not heat the first rotating member in a first state where the first rotating member does not rotate and the pressure between the first rotating member and the second rotating member is the second pressure, and heats the first rotating member when a second state where the first rotating member rotates and the pressure between the first rotating member and the second rotating member is the first pressure, is set in after the first state.

2. The apparatus of claim 1, wherein the first rotating member is electrically conductive and the heating mechanism is a coil which excites an induced current to the first rotating member.

3. The apparatus of claim 2, wherein the first rotating member is a belt which is electrically conductive belt and the heating mechanism is a coil which excites an induced current to the belt.

4. The apparatus of claim 3, wherein the first rotating member includes a roller which rotates the belt.

5. The apparatus of claim 4, wherein a surface of the roller is an elastic member which thermally expands.

6. The apparatus of claim 1, wherein the second rotating member contacts the first rotating member both when the first pressure is applied and when the second pressure is applied.

7. The apparatus of claim 1, further comprising:
a heater configured to heat the second rotating member.

8. The apparatus of claim 7, wherein after the pressure between the first rotating member and the second rotating member becomes the first pressure, the first rotating member rotates and the second state is set in.

9. The apparatus of claim 8, wherein after the first state, if the pressure between the first rotating member and the second rotating member becomes the first pressure, the heater heats the second rotating member.

10. The apparatus of claim 1, wherein in the first state, the first rotating member and the second rotating member do not fix the visualizing agent to the sheet, and
after the heating mechanism heats the first rotating member to a prescribed temperature in the second state, the first rotating member and the second rotating member presses the sheet with the first pressure to fix the visualizing agent to the sheet.

11. An image forming apparatus comprising:
a visualizing agent provision mechanism which supplies a visualizing agent to an electrostatically formed image;
a visualizing agent shift mechanism which shifts the visualizing agent supplied to the image by the visualizing agent provision mechanism, to a sheet medium; and
a fixing mechanism including:
a first rotating member;
a second rotating member which presses a sheet between the first rotating member and the second rotating member with a first pressure to fix a visualizing agent to the sheet;
a separation member which separates the sheet from the first rotating member;
a pressure control unit which lowers the pressure between the first rotating member and the second rotating member to a second pressure that is lower than the first pressure; and
a heating mechanism which does not heat the first rotating member in a first state where the first rotating member does not rotate and the pressure between the first rotating member and the second rotating member is the second pressure, and heats the first rotating member when a second state where the first rotating member rotates and the pressure between the first rotating member and the second rotating member is the first pressure, is set in after the first state.

12. The apparatus of claim 11, wherein the first rotating member is electrically conductive and the heating mechanism is a coil which excites an induced current to the first rotating member.

13. The apparatus of claim 12, wherein the first rotating member is an electrically conductive belt and the heating mechanism is a coil which excites an induced current to the belt.

14. The apparatus of claim 13, wherein the first rotating member includes a roller which rotates the belt.

15. The apparatus of claim 11, wherein the second rotating member contacts the first rotating member both when the first pressure is applied and when the second pressure is applied.

16. The apparatus of claim 11, further comprising:
a heater configured to heat the second rotating member.

17. The apparatus of claim 16, wherein after the pressure between the first rotating member and the second rotating member becomes the first pressure, the first rotating member rotates and the second state is set in.

18. The apparatus of claim 17, wherein after the first state, if the pressure between the first rotating member and the second rotating member becomes the first pressure, the heater heats the second rotating member.

19. The apparatus of claim 11, wherein in the first state, the first rotating member and the second rotating member do not fix the visualizing agent to the sheet, and
after the heating mechanism heats the first rotating member to a prescribed temperature in the second state, the first rotating member and the second rotating member presses the sheet with the first pressure to fix the visualizing agent to the sheet.

20. A toner image fixing method for pressing a sheet between a first rotating member and a second rotating member with a first pressure by the second rotating member and fixing a visualizing agent to the sheet, the method comprising:
not heating the first rotating member in a first state where the first rotating member does not rotate and the pressure between the first rotating member and the second rotating member is a second pressure; and
heating the first rotating member when a second state where the first rotating member rotates and the pressure between the first rotating member and the second rotating member is the first pressure, is set in after the first state.
